(19) United States
(12) Patent Application Publication
(10) Pub. No.: US 2012/0042292 A1
(43) Pub. Date: Feb. 16, 2012

(54) METHOD OF SYNTHESIS OF AN ELECTRONIC CIRCUIT

(75) Inventors: Fady Abouzeid, Grenoble (FR); Sylvain Clerc, Grenoble (FR); Fabian Firmin, Saint Martin D'heres (FR)

(73) Assignees: STMicroelectronics S.A., Montrouge (FR); Centre National de la Recherche Scientifique, Paris (FR); STMicroelectronics (Crolles 2) SAS, Crolles (FR)

(21) Appl. No.: 12/853,627

(22) Filed: Aug. 10, 2010

(51) Int. Cl. G06F 17/50

(52) U.S. Cl. 716/104

(57) ABSTRACT

A method of synthesis of at least one logic device coupled between first and second supply voltages and having a plurality of inputs and an output, the logic device including a plurality of transistors having a standard gate length, the method including: identifying, in the at least one logic device, one or more transistors connected between the first or second supply voltage and the output node; and increasing the gate length of each of the identified one or more transistors.

### FIELD OF THE INVENTION

The present invention relates generally to a method of synthesis of electronic circuits and to a cell library comprising a plurality of logic cells.

### BACKGROUND TO THE INVENTION

Digital circuits based on CMOS technology comprise one or more logic devices each comprising P-channel MOS transistors coupled to a supply voltage and N-channel MOS transistors coupled to a ground voltage. These transistors are controlled by one or more input signals to perform specific logic functions. Examples of such logic devices include OR-gates, AND-gates, NAND-gates, NOR-gates, XOR-gates and NOR-NAND gates. Such gates can be automatically assembled by computer systems in an operation known as logic synthesis.

To reduce current leakage and thus improve energy efficiency, it has been proposed to increase the gate lengths of each transistor in such logic devices. However, there is a trade-off in increasing gate lengths as this also leads to a reduction in the speed of the device.

In new CMOS technologies, it has been proposed to use ultra low supply voltages to further improve energy efficiency. However, while this considerably decreases current leakage, when combined with the increased gate lengths, this leads to a high performance penalty and an increase in area.

There is thus a need for an improved design strategy for maintaining energy efficiency as well as maintaining high operating speeds of such devices.

### SUMMARY OF THE INVENTION

It is an aim of at least one embodiment of the present invention to at least partially address one or more needs in the prior art.

According to one aspect of the present invention, there is provided a method of synthesis of at least one logic device coupled between first and second supply voltages and having a plurality of inputs and an output, the logic device comprising a plurality of transistors having a standard gate length, the method comprising: identifying, in said at least one logic device, one or more transistors connected between said first or second supply voltage and said output node; and increasing the gate length of each of said identified one or more transistors.

According to one embodiment, the identifying step further comprises identifying one or more transistors connected between said first or second supply voltage and one or more gates of said plurality of transistors.

According to another embodiment, each transistor identified in said identifying step is connected in parallel with at least one other of said plurality of transistors.

According to another embodiment, the method further comprises determining whether any of said plurality of transistors of said logic device forms an inverter, wherein during said identifying step transistors forming an inverter are excluded from identification.

According to another embodiment, the identifying step comprises identifying one or more transistors comprising a source connected to said first or said second voltage and a drain connected to said output node or one or more gates of said plurality of transistors.

According to another embodiment, the method further comprises, before said identifying step, synthesizing a layout of said at least one logic device such that each of said plurality of transistors of said at least one logic device has said standard length.

According to another embodiment, the method further comprises storing, in a cell library, a modified layout of said at least one logic device comprising said increased gate length of said identified one or more transistors.

According to another embodiment, the gate length of said identified one or more transistors is increased by between 1 and 100 percent.

According to another aspect of the present invention, there is provided an electronic storage medium storing a program that, when executed by a computer, implements the above method.

According to another aspect of the present invention, there is provided a cell library comprising a plurality of logic devices each coupled between first and second supply voltages and having a plurality of inputs and an output, wherein each of the plurality of logic devices comprises at least one transistor having a standard gate length, and one or more further transistors connected between said first or second supply voltage and said output node, each of said one or more further transistors having a gate length greater than said standard gate length.

According to another embodiment, each of said plurality of logic devices further comprises one or more further transistors connected between said first or second supply voltage and one or more gates of said plurality of transistors, each of said one or more further transistors having a gate length greater than said standard gate length.

According to another aspect of the present invention, there is provided an electronic storage medium storing the above cell library.

### BRIEF DESCRIPTION OF THE DRAWINGS

The foregoing and other purposes, features, aspects and advantages of the invention will become apparent from the following detailed description of embodiments, given by way of illustration and not limitation with reference to the accompanying drawings, in which:

FIG. 1 schematically illustrates an example of a logic device;

FIG. 2 is a flow diagram illustrating a method of synthesis according to an embodiment of the present invention;

FIG. 3A schematically illustrates a NOR gate;

FIG. 3B schematically illustrates the NOR gate of FIG. 3A in more detail to demonstrate how the method of FIG. 2 may be applied;

FIG. 4A schematically illustrates an AND-NOR gate;

FIG. 4B schematically illustrates the AND-NOR gate of FIG. 4A in more detail to demonstrate how the method of FIG. 2 may be applied;

FIG. 5A schematically illustrates an OR gate;

FIG. 5B schematically illustrates the OR gate of FIG. 5A in more detail to demonstrate how the method of FIG. 2 may be applied; and

FIG. 6 illustrates a computing device implementing the method of FIG. 2 according to embodiments of the present invention.

### DETAILED DESCRIPTION

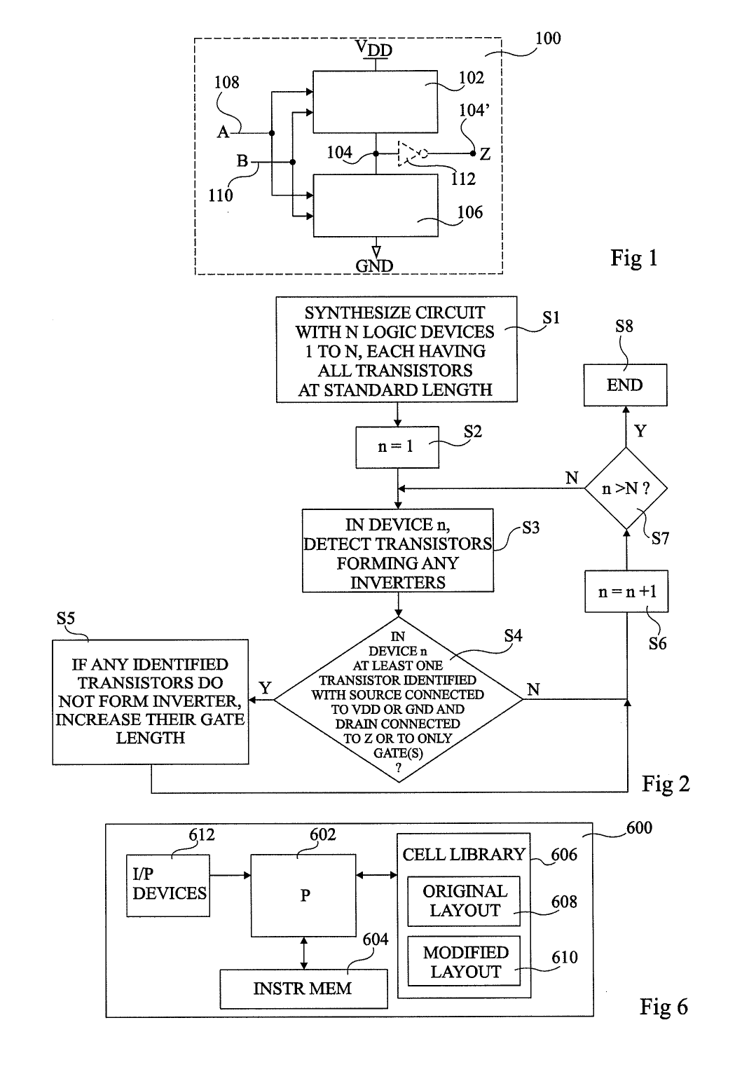

FIG. 1 illustrates a logic device 100 comprising a circuit block 102 coupled between a supply voltage VDD and an output node 104, and a circuit block 106 coupled between the output node 104 and a ground voltage GND. The supply voltage VDD is, for example, an ultra low voltage of 0.35 V, although other voltage levels are possible.

The transistors of the circuit blocks 102 and 106 are each controlled by one of a pair of input signals A and B provided on respective input lines 108 and 110. While not illustrated, there may be one or more additional input signals for controlling transistors of the circuit block 102 and/or 106. The output node 104 has a voltage which is either close to the supply voltage level VDD or close to the ground voltage GND, depending on whether transistors (not illustrated) of the circuit block 102 or those in the circuit block 106 are conducting. The output voltage Z of the device may be provided by the voltage at the output node 104 directly, or by the voltage at an output node 104′ after one or more optional inverters 112.

Assuming a CMOS implementation, the circuit block 102 comprises PMOS transistors, while the circuit block 106 comprises NMOS transistors. A method of selectively increasing the gate length of certain transistors of the circuit blocks 102, 106 will now be described with reference to the flow diagram of FIG. 2.

FIG. 2 illustrates steps in a method of synthesis of a circuit. The term synthesis is used herein to designate any automated method for computing dimensions of devices. The circuit comprises N logic devices, where N could be anywhere from 1 to several thousand. Each logic device has a structure similar to device 100 of FIG. 1.

In a first step S1, a digital circuit is synthesized having N logic devices, which are designated as devices 1 to N. In each logic device, all the transistors initially have a standard gate length for the technology concerned. For example assuming a 45 nm technology, in which the smallest photolithography interval is around 45 nm, the gate lengths of all transistors are, for example, initially at around 40 nm.

In a next step S2, a variable “n” is initialized at a value 1.

In a next step S3, any transistors forming inverters in device n are detected. For example, such transistors can be listed in a list “INVLIST”. A CMOS inverter is recognized as an NMOS transistor having its source connected to ground and a PMOS transistor having its source connected to VDD, the P and N channel transistors sharing common gate and drain nodes.

In a next step S4, the logic device n, initially being a first logic device of the devices 1 to N, is analyzed to determine whether at least one transistor is identified as having its source connected to supply voltage VDD or ground voltage GND, and its drain connected to the output voltage Z or to only gates in device n. In other words, it is determined whether the circuit block 102 of FIG. 1 comprises any transistors coupled directly between node 104 and VDD, or directly between node 104 and ground. If so, the next step is S5. Generally the transistors identified in step S4 will be in parallel with at least one other transistor. Optionally, step S4 comprises further filtering to identify only those transistors coupled in parallel with at least one other transistor.

In step S5, it is determined whether any transistors identified in step S4 form inverters, by for example checking whether they are included in the list “INVLIST”. Any identified transistors that do not form inverters have their gate lengths increased with respect to the standard length. The next step after S5, and after S4 in the case that no transistors are identified, is S6.

In step S6, n is incremented. The next step is S7.

In S7 it is determined whether n is higher than N, in other words whether the final logic device has been analyzed. If not, the method returns to S3. If n is greater than N in step S7, the next step is S8 in which the method ends.

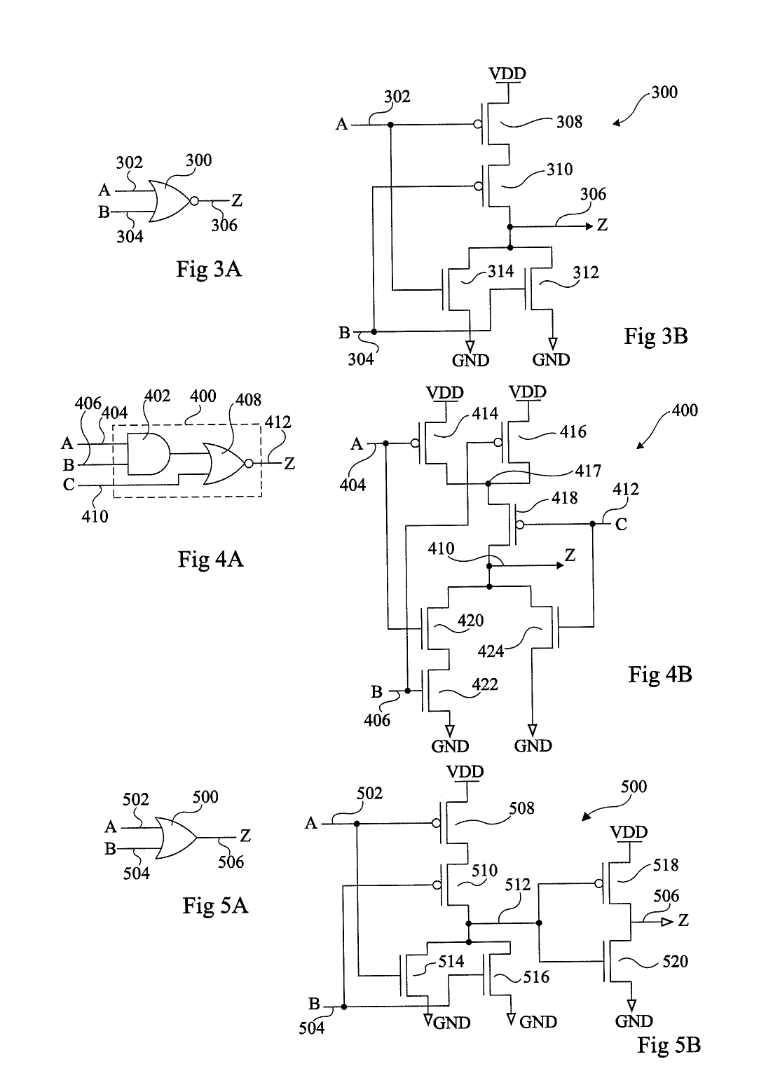

Examples of the application of the method of FIG. 2 will now be described in more detail with reference to examples of logic devices of FIGS. 3A, 3B, 4A, 4B, 5A and 5B.

FIG. 3A illustrates a NOR-gate 300 comprising input lines 302 and 304, and an output line 306.

FIG. 3B illustrates the NOR-gate of FIG. 3A in more detail in which PMOS transistors 308 and 310 are coupled in series to the output line 306 and the supply voltage VDD. These transistors 308, 310 correspond to the circuit block 102 of FIG. 1. Transistors 312 and 314 are coupled in parallel between the output line 306 and the ground voltage GND. These transistors 312, 314 correspond to the circuit block 106 of FIG. 1. Transistors 308 and 314 receive at their gate nodes the control signal A on line 302, while the transistors 310 and 312 receive at their gate nodes the control signal B on line 304.

Applying the method of FIG. 2, in step S3 no transistor forming an inverter will be identified in the logic device 300. In step S4, both the transistors 312 and 314 will be identified, as each is connected directly between the output line 306 and the ground voltage GND. Then, in step S5, both the transistors 312, 314 will be identified as not forming inverters. Thus, the gate lengths of both transistors 312 and 314 will be increased.

The increase in gate length applied to the transistors will depend on various factors, such as their original length and the level of the supply voltage. In the case that the transistors 308, 310, 312 and 314 all initially have the standard gate length of 40 nm, the gate lengths of transistors 312 and 314 are, for example, increased to around 50 nm, in other words by around 20 percent. In alternative embodiments, the increase could be anywhere between 1 and 100 percent, or even higher, depending on design specifications.

FIG. 4A illustrates an AND-NOR gate 400 comprising an AND gate 402 having input lines 404 and 406 for receiving input signals A and B respectively, and a NOR-gate 408, which receives the output of AND gate 402 and an input signal C on an input line 410, and provides the output voltage Z on an output line 412. While the logic device 400 comprises two logic components 402 and 408, the implementation, as will now be described with reference to FIG. 4B, comprises three input terminals and a single output terminal, and thus is considered herein as a single logic device.

FIG. 4B shows the logic device 400 in more detail as comprising PMOS transistors 414 and 416 coupled between the supply voltage VDD and a node 417. Node 417 is in turn coupled to the output line 410 via a PMOS transistor 418. The transistors 414, 416 and 418 correspond to the circuit block 102 of FIG. 1, in the case that circuit blocks 102 and 106 additionally receive the input C.

The logic device 400 also comprises NMOS transistors 420 and 422 coupled in series between the output line 410 and the ground voltage GND, and an NMOS transistor 424 connected directly between the output line 410 and the ground voltage GND.

The transistors 414 and 420 receive, at their gate nodes, the control signal A on an input line 404, while the transistors 416 and 422 receive, at their gate nodes, the input signal B via an input line 406. The transistors 418 and 424 receive at their gate nodes the signal C via an input line 412.

Applying the method of FIG. 2, in step S3 no transistor will be identified as forming an inverter. In step S4, the transistor 424 will be identified as being coupled directly between the output line 412 and the ground voltage GND. Furthermore, in step S5, it will be determined that the transistor 424 does not form an inverter. Thus, the gate length of transistor 424 will be increased.

FIG. 5A illustrates an OR gate 500 comprising input lines 502 and 504, and an output line 506.

FIG. 5B illustrates the OR gate 500 of FIG. 5A in more detail in which PMOS transistors 508 and 510 are coupled in series between a node 512 and the supply voltage VDD. Transistors 508, 510 correspond to the circuit block 102 of FIG. 1. Furthermore, NMOS transistors 514 and 516 are coupled in parallel between the node 512 and the ground voltage GND. Transistors 514, 516 correspond to the circuit block 106 of FIG. 1. Transistors 508 and 514 receive at their gate nodes the control signal A on line 502, while transistors 510 and 516 receive, at their gate nodes, the control signal B on line 504. Node 512 is connected to the gate nodes of a PMOS transistor 518 and of an NMOS transistor 520. Transistors 518 and 520 form an inverter, transistor 518 being connected between the supply voltage VDD and the output node 506, and transistor 520 being connected between the ground voltage GND and the output node 506.

Applying the method of FIG. 2, in step S3, transistors 518 and 520 are identified as forming an inverter, and, for example, they will be indicated in a list “INVLIST”. In step S4, both the transistors 514 and 516 will be identified, as each is connected directly between the ground voltage GND and the gates of transistors 518 and 520. Furthermore, transistors 518 and 520 will also be identified, as each is connected directly between the output Z and supply voltage VDD or ground voltage GND. In step S5, both the transistors 514 and 516 will be identified as not forming inverters, as they are not included in the list “INVLIST”. Thus, the gate lengths of both transistors 514 and 516 will be increased, whereas the gate lengths of transistors 518 and 520 will not be increased as these will be identified as inverters.

FIG. 6 illustrates a computing device 600 for implementing the method of FIG. 2 according to one example.

The computing device 600 comprises a processor 602, controlled by instructions loaded from an instruction memory 604. A further memory 606 contains a cell library, with a portion 608 storing one or more original layouts of synthesized logic devices having a standard gate length. Memory 606 also comprises a portion 610, which stores one or more modified layouts 610 of the logic devices, in which the gate length of at least some of the transistors have been selectively increased based on the method described herein.

In particular, under the control of the instruction memory 604, the processor 602 is arranged to take original logic device layouts from memory portion 608, perform the steps of FIG. 2 to generate modified logic device layouts, and to store them in the memory portion 610.

It will be apparent to those skilled in the art that, in alternative embodiments, the memory 606 storing the cell library could be at a remote location with respect to the computing device 600, for example coupled to the computing device 600 via an intermediate wired or wireless network.

The present inventors have found that, by selectively increasing the gate lengths of transistors coupled directly between the supply or ground voltages and the output voltage Z or the gate of another transistor, the overall current leakage can be significantly reduced without significantly reducing the speed of the device. On the contrary, the present inventors have found that where multiple transistors are coupled in series between one of the supply voltages and the output node, an increase in the gate lengths of these transistors has a high impact on the speed of the device, and a lesser impact on the current leakage. Preferably, the gate lengths of transistors forming the inverter are not increased.

As an example, on average over a number of devices, applying the selective gate enlargement of the present invention, assuming an initial gate length of 40 nm, an enlarged length of 50 nm, and a supply voltage of 0.35 V, resulted in only a 4 percent increase in delay time, but still a reduction in current leakage of nearly 30 percent. This can be compared with a 50 percent increase in delay times if the gate lengths of the transistors are all enlarged. Similar results can be seen when the supply voltage is at 1.1 V.

Furthermore, an advantage of providing a cell library containing logic devices synthesized according to the method described herein is that circuits generated using such a cell library will have relatively high speed and low current leakage.

Having thus described at least one illustrative embodiment of the invention, various alterations, modifications and improvements will readily occur to those skilled in the art.

For example, while a number of specific examples of applications of the synthesis method described herein have been given with reference to FIGS. 3B, 4B, and 5B it will be apparent to those skilled in the art that the method may be applied to a wide range of logic devices having any number of inputs and one or more outputs.

Furthermore, while examples have been described that use CMOS technology at 45 nm, it will be apparent to those skilled in the art that the synthesis method described herein could be applied to other CMOS technologies such as 65 nm or 32 nm, or to technologies other than CMOS.

Additionally, the synthesis method can be applied to a library of cells having larger gate sizes than a standard gate size, in order to selectively enlarge some gate cells to an even greater extent.

Such alterations, modifications and improvements are intended to be within the spirit and scope of the invention. Accordingly, the foregoing description is by way of example only and is not intended to be limiting. The invention is limited only as defined in the following claims and the equivalent thereto.

What is claimed is:

1. A method of synthesis of at least one logic device coupled between first and second supply voltages (VDD, GND) and having a plurality of inputs and an output, the logic device comprising a plurality of transistors having a standard gate length, the method comprising:
identifying, in said at least one logic device, one or more transistors connected between said first or second supply voltage and said output node; and
increasing the gate length of each of said identified one or more transistors.

2. The method of claim 1, wherein said identifying step further comprises identifying one or more transistors connected between said first or second supply voltage and one or more gates of said plurality of transistors.

3. The method of claim 1, wherein each transistor identified in said identifying step is connected in parallel with at least one other of said plurality of transistors.

4. The method of claim 1, further comprising determining whether any of said plurality of transistors of said logic device forms an inverter, wherein during said identifying step transistors forming an inverter are excluded from identification.

5. The method of claim 1, wherein said identifying step comprises identifying one or more transistors comprising a source connected to said first or said second voltage and a drain connected to said output node or one or more gates of said plurality of transistors.

6. The method of claim 1, further comprising, before said identifying step, synthesizing a layout of said at least one logic device such that each of said plurality of transistors of said at least one logic device has said standard length.

7. The method of claim 1, further comprising storing, in a cell library, a modified layout of said at least one logic device comprising said increased gate length of said identified one or more transistors.

8. The method of claim 1, wherein the gate length of said identified one or more transistors is increased by between 1 and 100 percent.

9. An electronic storage medium storing a program that, when executed by a computer, implements the method of claim 1.

10. A cell library comprising a plurality of logic devices each coupled between first and second supply voltages and having a plurality of inputs and an output, wherein each of the plurality of logic devices comprises at least one transistor having a standard gate length, and one or more further transistors connected between said first or second supply voltage and said output node, each of said one or more further transistors having a gate length greater than said standard gate length.

11. The cell library of claim 10, wherein each of said plurality of logic devices further comprises one or more further transistors connected between said first or second supply voltage and one or more gates of said plurality of transistors, each of said one or more further transistors having a gate length greater than said standard gate length.

12. An electronic storage medium storing the cell library of claim 10.
